(19) United States
(12) Patent Application Publication
(10) Pub. No.: US 2010/0266885 A1
(43) Pub. Date: Oct. 21, 2010

(54) Battery cooling apparatus

(75) Inventor: Mario John Dominic Lee, Santa Clara, CA (US)

Correspondence Address: Altis Law Group, Inc.;ATTN: Steven Reiss, 288 SOUTH MAYO AVENUE, CITY OF INDUSTRY, CA, 91789, US

(73) Assignee: HON HAI Precision Industry CO., LTD., Tu-Cheng City (TW)

(21) Appl. No.: 12/456,058

(22) Filed: Jun. 11, 2009

(30) Foreign Application Priority Data
Apr. 20, 2009 (CN) 200920302396.X

(51) Int. Cl. H01M 10/50

(52) U.S. Cl. 429/120

(57) ABSTRACT

A battery cooling apparatus includes at least one battery, a thermo-electronic device, and a heat pipe. The heat pipe is in thermal contact with the thermo-electronic device at a first end of the heat pipe and in thermal contact with the at least one battery at a second end of the heat pipe.

### BACKGROUND

1. Technical Field

The present disclosure relates to a battery cooling apparatus and, particularly, to a battery cooling apparatus in an electronic device.

2. Description of Related Art

A server has many backup batteries for avoiding data loss should the regular power source fail. The batteries generate heat when they are used. However, no special cooling apparatus for the batteries is supplied in the server. It may influence life of the batteries if the heat generated by the batteries cannot be timely dissipated.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a front view of a battery cooling apparatus;

FIG. 2 is a top view of the battery cooling apparatus; and

FIG. 3 is a front view of the battery cooling apparatus assembled with four batteries.

### DETAILED DESCRIPTION

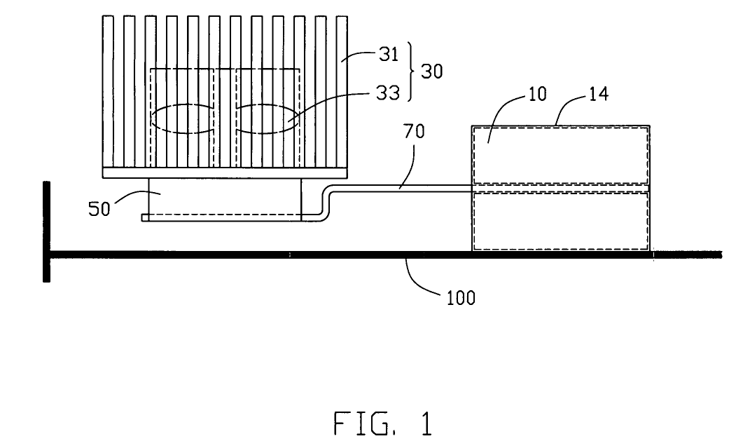

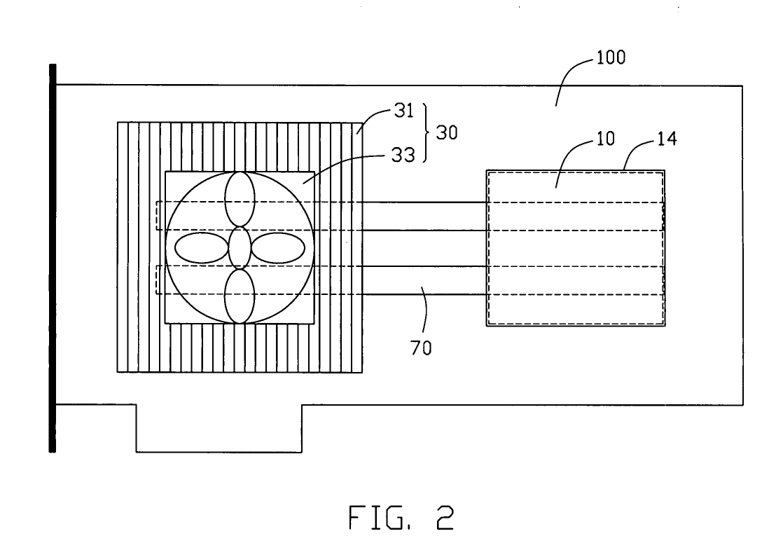

Referring to FIG. 1 and FIG. 2, a battery cooling apparatus is configured for dissipating heat from two batteries 10 above an expansion card 100. The batteries 10 are mounted in a heat collector 14. The batteries 10 provide a plurality of discharge/charge cycles. The batteries 10 generate heat when the batteries 10 are charging or discharging. The battery cooling apparatus includes a heat sink 30, a thermo-electronic device 50 and a heat pipe 70. The thermo-electronic device 50 uses the Peltier effect to create a heat flux between the junction of two different types of materials. The thermo-electronic device 50 is a solid-state active heat pump which transfers heat from one side of the device to the other side against the temperature gradient (from cold to hot), with consumption of electrical energy. The effectiveness of the device at moving the heat away from the cold side is totally dependent upon the amount of current provided.

The heat sink 30 is fixed at one side of the heat collector 14. The heat sink 30 includes a plurality of fins 31 and a fan 33 surrounded by the fins 31. The fins 31 are made of heat conducting material to dissipate heat. The fan 33 is configured for moving air from one side to the other side of the fins 31 to accelerate heat dissipation.

The thermo-electronic device 50 is a thermoelectric transistor. The thermo-electronic device 50 is attached to the heat sink 30. The thermo-electronic device 50 includes a heat surface and a cold surface. An end of the heat pipe 70 is fixed on a bottom portion of the thermo-electronic device 50 to contact the cold surface of the thermo-electronic device 50. The heat pipe 70 is made of heat conducting materials. The heat pipe 70 carries heat from the batteries 10 to the heat sink 30.

The battery cooling apparatus is mounted on one side of the heat collector 14. Another end of the heat pipe 70 is inserted into the heat collector 14, and is situated adjacent to the batteries 10. When the battery cooling apparatus works, the heat pipe 70 carries heat from the batteries 10 to the thermo-electronic device 50. The thermo-electronic device 50 receives heat from the heat pipe 70. The cold surface of the thermo-electronic device 50 is in contact with the heat pipe 70, and dissipates heat to the heat surface of the thermo-electronic device 50. The heat surface of the thermo-electronic device 50 transfers the heat to the heat sink 30. The thermo-electronic device 50 transfers the heat away from the batteries 10 and is capable of reducing the temperature of the batteries 10 below ambient temperature. Thus, the heat generated by the batteries 10 is transferred to the heat sink 30 through the heat pipe 70 and the thermo-electronic device 50. The heat sink 30 dissipates the heat via the fins 31 and the fan 33. The temperature of the batteries 10 is reduced by the battery cooling apparatus. The battery cooling apparatus extends life of the batteries 10.

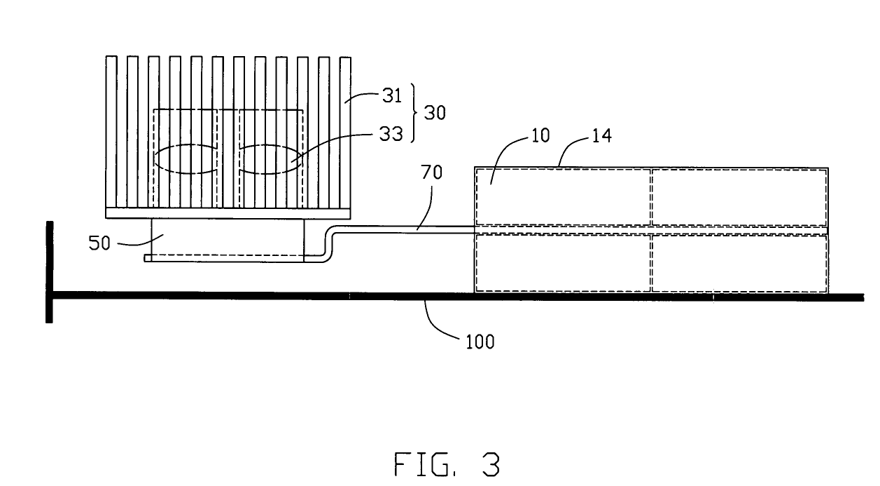

Referring to FIG. 3, the heat collector 14 can receive multiple batteries 10. The heat pipe 70 is inserted among the batteries 10. The battery cooling apparatus is capable of carrying heat from the batteries 10 to extend the battery life.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cooling apparatus comprising:
at least one battery;
a thermo-electronic device; and
a heat pipe in thermal contact with the thermo-electronic device at a first end of the heat pipe and in thermal contact with the at least one battery at a second end of the heat pipe.

2. The battery cooling apparatus of claim 1, further comprising a heat sink attached to the thermo-electronic device.

3. The battery cooling apparatus of claim 2, wherein a fan is installed in the heat sink, and the fan is capable of generating airflow towards the thermo-electronic device.

4. The battery cooling apparatus of claim 1, wherein the thermo-electronic device comprises a heat surface and a cold surface, the heat pipe is in contact with the cold surface.

5. The battery cooling apparatus of claim 1, wherein a heat collector surrounds the at least one battery to collect heat.

6. The battery cooling apparatus of claim 1, wherein the at least one battery comprises two batteries, and at least a part of the heat pipe is located between the two batteries.

7. A battery cooling apparatus comprising:
at least one battery;
a heat sink;
a thermo-electronic device attached to the heat sink; and
a heat pipe thermally contacting the thermo-electronic device and the at least one battery.

8. The battery cooling apparatus of claim 7, wherein a plurality of fins is formed on the heat sink, and the fins are perpendicular to the thermo-electronic device.

9. The battery cooling apparatus of claim 8, wherein a fan is installed in a middle portion of the fins, and the fan is capable of generating airflow towards the thermo-electronic device.

10. The battery cooling apparatus of claim 7, wherein the thermo-electronic device comprises a heat surface and a cold surface, the heat pipe is in contact with the cold surface.

11. The battery cooling apparatus of claim 7, wherein a heat collector surrounds the at least one battery to collect heat.

12. The battery cooling apparatus of claim 7, wherein the at least one battery comprises two batteries, and at least a part of the heat pipe is located between the two batteries.
